(19) United States
(12) Patent Application Publication
(10) Pub. No.: US 2010/0295698 A1
(43) Pub. Date: Nov. 25, 2010

(54) Remote Control Setting Method and Device for Electronic Device and Remote Control System

(76) Inventors: Yi-Shang Chen, Taipei Hsien (TW); Chun-Hao Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/650,570

(22) Filed: Dec. 31, 2009

(30) Foreign Application Priority Data
May 21, 2009 (TW) 098116849

(51) Int. Cl. G08B 5/22; G08C 19/00

(52) U.S. Cl. 340/825.36; 340/825.69

(57) ABSTRACT

A remote control setting method for an electronic device for setting a plurality of functions of the electronic device to be controlled by a plurality of keypads of a remote controller includes displaying an indication message according to a control signal, to indicate codes of a function of the plurality of functions and ask a user to press a keypad of the plurality of keypads, receiving a triggering signal generated by pressing the keypad, and storing codes including relation between the triggering signal and the function according to the control signal.

### BACKGROUND OF THE INVENTION

1. Field of the Invention

The present invention is related to a remote control setting method and device for an electronic device and remote control system, and more particularly, to a remote control setting method and device and remote control system capable of enhancing convenience.

2. Description of the Prior Art

With the advancement of electronic technology, various electronic devices play an important role in the modern society. Consumer audio/video equipments, such as TV, CD player, DVD player, etc., are widely used in daily life. To enhance convenience, most audio/video equipments are equipped with remote controllers, such that a user can willfully control the audio/video equipments via the remote controllers.

A conventional infra-red remote controller is “one-to-one”. That is, an audio/video equipment is equipped with a dedicated remote controller, and every function of the audio/video equipment is invariably corresponding to a control signal having specific controlling codes. The remote controller includes keypads for controlling different functions of the audio/video equipment. Thus, the user can press one of the keypads to emit a control signal carrying codes corresponding to a desired function via the remote controller. Once the audio/video equipment receives the control signal, codes carried by the control signal is recognized, and the audio/video equipment can perform the corresponding function accordingly.

Since each audio/video equipment is equipped with a dedicated remote controller, as the amount of audio/video equipments possessed by the user increases, the user has to get familiar with more different remote controllers, causing utilization inconvenience. In addition, once a remote controller is lost, the user has to buy an identical remote controller to control a corresponding audio/video equipment, causing inconvenience as well. Furthermore, for a consumer, when purchasing audio/video equipments, remote controllers of old audio/video equipments cannot consist with the new audio/video equipments, leading to the waste of resources due to poor expandability.

### SUMMARY OF THE INVENTION

It is therefore a primary objective of the claimed invention to provide a remote control setting method and device for an electronic device and remote control system.

The present invention discloses a remote control setting method for an electronic device for setting a plurality of functions of the electronic device to be controlled by a plurality of keypads of a remote controller. The remote control setting method comprises receiving a control signal, recognizing the control signal and corresponding the recognized control signal codes to codes generated by a specific keypad with the same function, and storing the codes in a memory.

The present invention further discloses a remote control setting device for an electronic device for setting a plurality of functions of the electronic device to be controlled by a plurality of keypads of a remote controller. The remote control setting device comprises a receiver for receiving a control signal generated by pressing a keypad of the plurality of keypads, a control unit, for receiving and recognizing signals of the remote controller to generate and store the codes corresponding to specific keypads with the same function, and a storage unit, for storing codes of the specific keypads.

The present invention further discloses a remote control system capable of setting remote control functions. The remote control system comprises a remote controller, comprising a plurality of keypads, an electronic device, comprising a plurality of functions, and a remote control setting device, installed in the electronic device, comprising a receiver for receiving a control signal generated by pressing a keypad of the plurality of keypads, a control unit for receiving and recognizing signals of the remote controller to generate and store codes corresponding to specific keypads with the same function, and a storage unit for storing codes of the specific keypads.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a remote control system according to an embodiment of the present invention.

FIG. 2 is a schematic diagram of a remote control setting device of FIG. 1.

FIG. 3 is a schematic diagram of a remote control setting process according to an embodiment of the present invention.

FIG. 4 is a schematic diagram of a mapping table according to an embodiment of the present invention.

### DETAILED DESCRIPTION

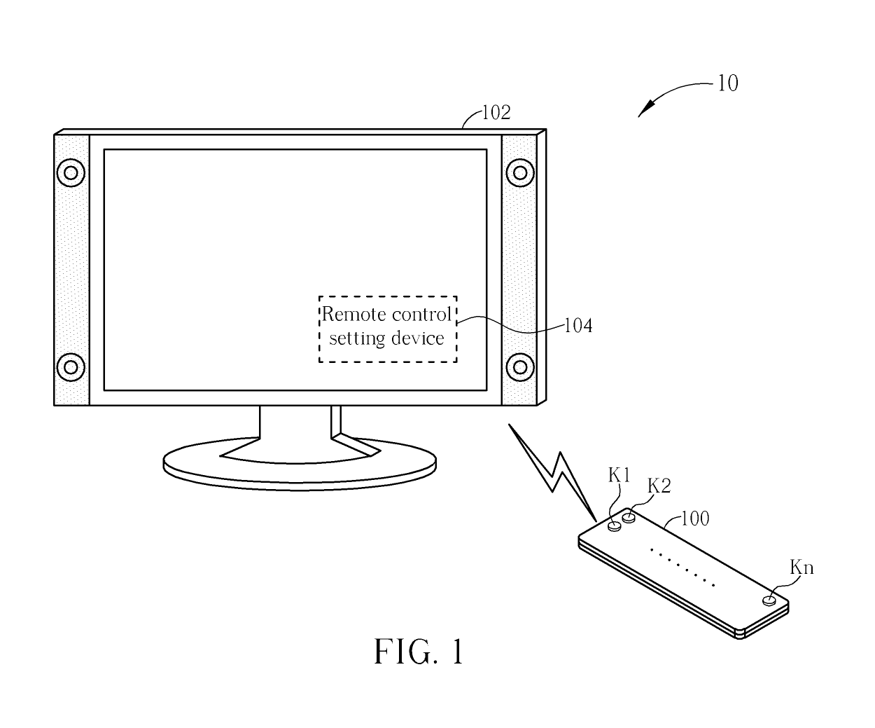

Please refer to FIG. 1, which is a schematic diagram of a remote control system 10 according to an embodiment of the present invention. The remote control system 10 is preferably an infra-red remote control system, and a user can customize remote control functions of the remote control system 10. The remote control system 10 includes a remote controller 100, an electronic device 102 and a remote control setting device 104. The remote controller 100 includes various kinds of keypads, which are at least corresponding to keypads of a default brand remote controller, such as volume+, volume−, 0, 1, 2, 3, 4, 5, 6, 7, 8, 9, power, channel+, channel−, etc. When one of the keypads is pressed, a corresponding control signal is generated. Note that, the electronic device 102 can preferably be a TV or the likes. The remote control setting device 104 is installed in the electronic device 102, and utilized for setting functions 1˜m of the electronic device 102 to be controlled by the remote controller 100, or namely, setting the keypads of the remote controller 100 to control the functions 1˜m.

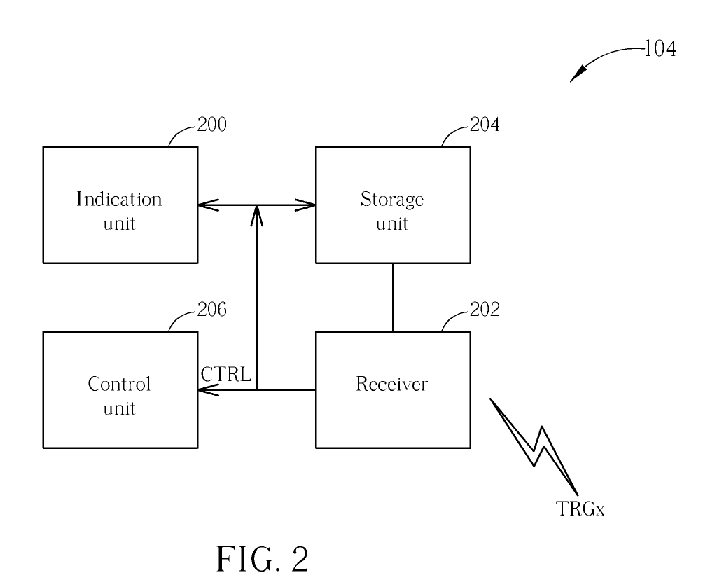

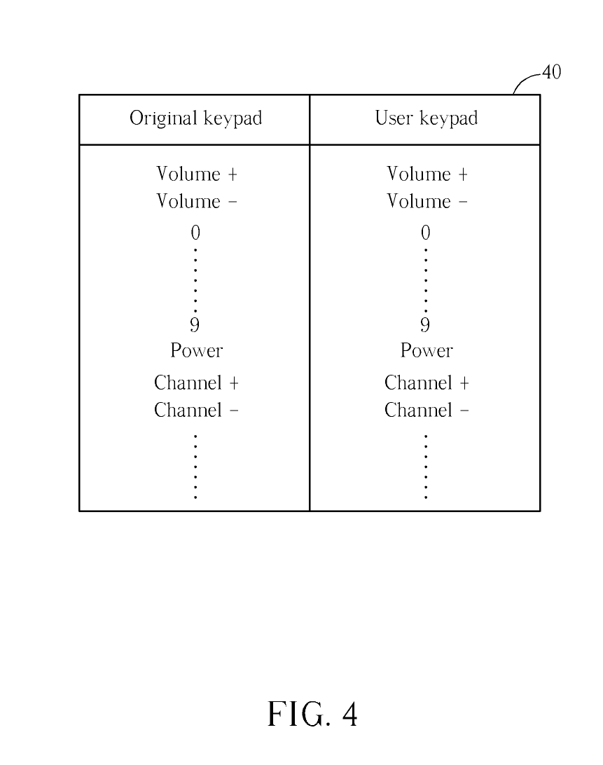

Please continue to refer to FIG. 2, which is a schematic diagram of the remote control setting device 104 shown in FIG. 1. The remote control setting device 104 includes an indication unit 200, a receiver 202, a storage unit 204 and a control unit 206. The receiver 202 is utilized for receiving a control signal TRGx generated by pressing one of the keypads of the remote controller 100. The control unit 206 is utilized for recognizing the received control signal TRGx to generate codes corresponding to the pressed keypad with the same function, and transmitting the codes to the storage unit 204. The storage unit 204 is utilized for storing the control signal codes to a corresponding memory address. Since the user sequentially presses the keypads of the remote controller 100 not yet configured, codes corresponding to the codes of pressed keypads with the same function can be sequentially stored in a memory space after the user's operation. The indication unit 200 is utilized for displaying an indication message according to a control signal CTRL, to indicate codes of a specific function and ask the user to press one of the keypads. As illustrated in FIG. 4, codes corresponding to the keypads are volume+, volume−, 0, 1, etc.

In short, when setting the electronic device 102 to be controlled by the remote controller 100, e.g. when the electronic device 102 is first-time powered on after leaving the factory or a remote control setting keypad (not shown in FIG. 1 and FIG. 2) of the electronic device 102 is pressed, the remote control setting device 104 controls the indication unit 200 to correspondingly displays codes of the indication message, so as to remind the user to press a keypad corresponding to a next function, and store related codes. As a result, via the remote controller 100, the user can store keypad codes of the electronic device 102 in the storage unit 204 of the remote control setting device 104. That is, in addition to the brand remote controller of the electronic device 102, the user can set a different remote controller to control the electronic device 102. In such a way, a manufacturer of the electronic device 102 can individually sell the electronic device 102 without a remote controller since the electronic device 102 can be controlled by an produced remote controller, so as to reduce price.

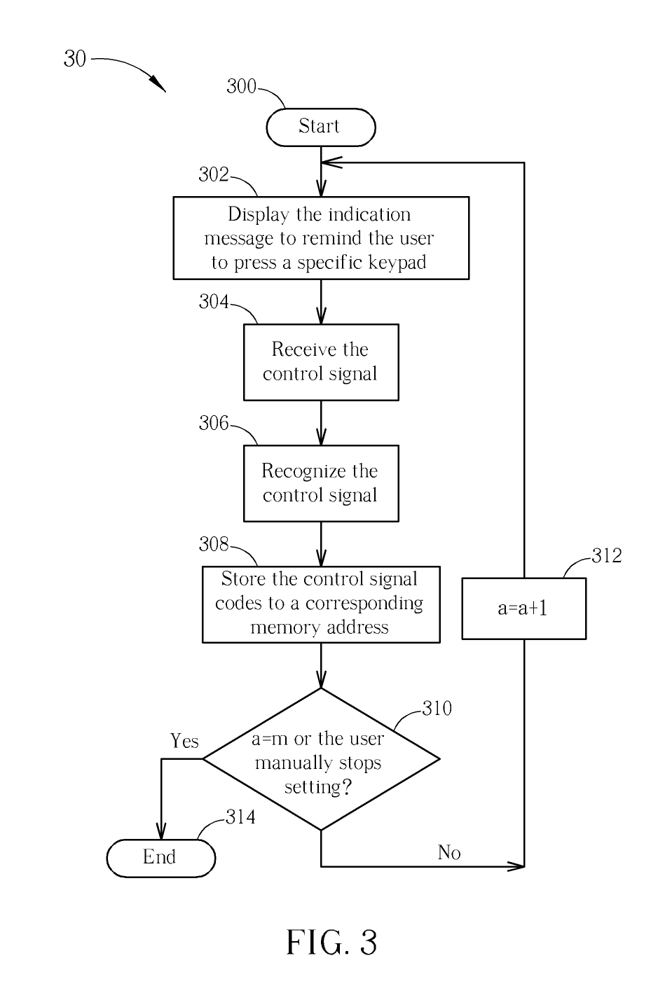

For more details about operations of the remote control setting device 104, please refer to FIG. 3, which is a schematic diagram of a remote control setting process 30 of the remote control setting device 104. The remote control setting process 30 includes the following steps:

Step 300: Start.

Step 302: The indication unit 200 displays the indication message to remind the user to press a specific keypad with the same function.

Step 304: The receiver 202 receives the control signal generated by pressing the keypad.

Step 306: The control unit 206 recognizes the control signal.

Step 308: Store the recognized control signal codes to a corresponding memory address.

Step 310: The control unit 206 determines whether all the functions 1˜m are set (i.e. whether a variable “a” is equal to m) or whether the user manually stops setting. If one of the determination conditions is true, proceed to Step 314; else, proceed to Step 312.

Step 312: Proceed to set the next function, i.e. a=a+1.

Step 314: End.

According to the remote control setting process 30, when setting the electronic device 102 to be controlled by the remote controller 100, the control unit 206 first controls the indication unit 200 to display the indication message, to indicate codes of a function Fa to be currently set and remind the user to press a desired keypad. Next, the receiver 202 receives the control signal TRGx generated by pressing the specific keypad, and the storage unit 204 stores the codes corresponding to the remote control function. Finally, the control unit 206 determines whether all the functions, such as the functions 1˜m, are set; that is, determine whether the variable a is equal to m. If the functions are not completely set, the control unit 206 determines whether the user manually stops the remote control setting process, e.g. detects whether the user presses a stop setting keypad, and proceeds to set the next function if the user does not manually stop setting. In short, when setting the electronic device 102 to be controlled by the remote controller 100, the remote control setting device 104 sequentially indicates codes of a function to be currently set to the user and remind the user to press a corresponding keypad, to set the function to be triggered by the keypad. Such a process is repeated to complete settings of all functions. As a result, the user can control the electronic device 102 via the remote controller 100.

Note that, the remote control system 10 and the remote control setting process 30 are embodiments of the present invention, and can be modified by those skilled in the art. For example, the electronic device 102 can further include a remote control setting keypad, for triggering the settings of the remote control functions, and a stop setting keypad, for forcing the electronic device 102 to close the settings of the remote control functions. In addition, the electronic device 102 can be preset with one or more configuration sets of the remote control functions, e.g. a configuration set of the brand remote controller, such that the user can directly buy the brand remote controller and choose the configuration set, so as to enhance convenience. Besides, in the remote control setting device 104, the storage unit 204 stores the control signals codes of the keypads and relation between the control signals codes and the corresponding functions codes, and can preferably be implemented by a mapping table 40, as illustrated in FIG. 4. In FIG. 4, the first column shows codes of the functions of the electronic device 102, such as volume+, volume−, 0, 1, 2, 3, 4, 5, 6, 7, 8, 9, power, channel+, channel−, etc., and the second column shows keypads to be customized by the user. Note that, the quantity of the keypads of the employed remote controller can be unequal to that of the brand remote controller, but the keypads of the employed remote controller should be pressed according to an indicated order, to correctly generate the corresponding control signals.

In the prior art, each electronic device is equipped with a dedicated remote controller, i.e. one-to-one. Once a remote controller is lost, the user has to buy an identical remote controller to resume the usage of a corresponding electronic device. In comparison, according to the present invention, the user can manually replace with a remote controller and set keypads to be related to corresponding functions. As a result, even if the remote controller is lost or malfunctioned, the user can use other remote controllers for replacement. Meanwhile, the manufacturer of the electronic device can separately sell the electronic device and the remote controller, to provide a more competitive price.

To sum up, the present invention allows the user to manually define relation between the functions of the electronic device and the keypads of the remote controller, to enhance convenience. Meanwhile, the manufacturer can separately sell the electronic device and the remote controller, to cut price, and enhance competitiveness.

Those skilled in the art will readily observe that numerous modifications and alterations of the device and method may be made while retaining the teachings of the invention.

What is claimed is:

1. A remote control setting method for an electronic device for setting a plurality of functions of the electronic device to be controlled by a plurality of keypads of a remote controller, comprising:
receiving a control signal;
recognizing the control signal and corresponding the recognized control signal codes to codes generated by a pressed specific keypad; and
storing the codes in a memory.

2. The remote control setting method of claim 1 further comprising:
displaying an indication message, to indicate a user to press specific keypads.

3. The remote control setting method of claim 2, wherein displaying the indication message is displaying the indication message by means of audio signals via an audio outputting device of the electronic device and reminding the user to press the keypads.

4. A remote control setting device for an electronic device for setting a plurality of functions of the electronic device to be controlled by a plurality of keypads of a remote controller, comprising:
a receiver, for receiving a control signal generated by pressing a keypad of the plurality of keypads;
a control unit, for receiving and recognizing signals of the remote controller, to generate and store codes corresponding to codes generated by a pressed specific keypad; and
a storage unit, for storing codes of the specific keypad.

5. The remote control setting device of claim 4 further comprising:
an indication unit, for displaying an indication message according to a control signal, to indicate a user to press a keypad of the plurality of keypads.

6. The remote control setting device of claim 4, wherein the indication unit generates the indication message by means of audio signals via an audio outputting device of the electronic device and asks the user to press the keypad.

7. A remote control system capable of setting remote control functions comprising:
a remote controller, comprising a plurality of keypads;
an electronic device, comprising a plurality of functions; and
a remote control setting device, installed in the electronic device, comprising:
a receiver, for receiving a control signal generated by pressing a keypad of the plurality of keypads;
a control unit, for receiving and recognizing signals of the remote controller, to generate and store codes corresponding to specific keypads; and
a storage unit, for storing codes of the specific keypads.

8. The remote control system of claim 7 further comprising:
an indication unit, for displaying an indication message according to a control signal, to indicate a user to press a keypad of the plurality of keypads.

9. The remote control system of claim 7, wherein the indication unit generates the indication message by means of audio signals via an audio outputting device of the electronic device and asks the user to press the keypad.
